(19) United States
(12) Patent Application Publication
(10) Pub. No.: US 2026/0147525 A1
(43) Pub. Date: May 28, 2026

(54) AUDIO DEVICE AND CONTROL METHOD

(71) Applicant: Realtek Semiconductor Corporation, Hsinchu (TW)

(72) Inventors: Chun-Hao PENG, Hsinchu (TW); Chun Hao LAI, Hsinchu (TW)

(21) Appl. No.: 19/257,414

(22) Filed: Jul. 1, 2025

(30) Foreign Application Priority Data
Nov. 27, 2024 (TW) 113145776

(51) Int. Cl. G06F 3/16

(52) U.S. Cl. CPC G06F 3/162; G06F 3/165

(57) ABSTRACT

An audio device includes an input/output interface, a search circuit, a memory, and a processor. The input/output interface is configured to receive at least one SDCA audio topology control item from an audio system host. The search circuit is configured to search a target index from an address correspondence table according to a plurality of key information of at least one SDCA audio topology control item, to point to a target control item and a target storage addresses through the target index, and to transmit an interrupt signal corresponding to the target control item. The processor is configured to obtain the operation program corresponding to the interrupt signal from the memory according to the interrupt signal, and to execute operations at the target storage address corresponding to the target control item based on the operation program to control the audio device.

### CROSS-REFERENCE TO RELATED APPLICATION

This application claims priority to Taiwan Application Serial Number 113145776, filed Nov. 27, 2024, which is herein incorporated by reference in its entirety.

### BACKGROUND

### Field of Invention

The embodiments described in the present disclosure relate to an audio device and a control method, in particular, relate to an audio device and a control method utilizing the SDCA technical standard. SDCA means “SoundWire Device Class for Audio” and is a standardized interface found on MIPI (Mobile Industry Processor Interface) SoundWire audio devices.

### Description of Related Art

The SDCA technical standard provides a detailed set of technical specifications describing how to utilize SDCA to control audio devices. According to the SDCA technical standard, an audio device or audio physical device includes one or more SDCA functions. Each SDCA function has a corresponding SDCA function driver for controlling the audio physical device and adjusting the operation behavior of the device, such as changing the sound volume, adjusting the audio sampling rate, and controlling the power switch.

Traditionally, when the audio system host controls the audio device, the host system software selects the corresponding SDCA function driver based on the audio function topology type of the audio physical device, and then provides various SDCA audio topology control items to the audio device for various controls through the transmission of the bus. The port physical layer of the audio device receives the data packets from the bus. After decoding, the information would be transmitted to the digital interface. The digital interface determines whether the address of this SDCA audio topology control item is supported. If it is supported, the digital interface directs the control data of the control item to the corresponding memory space. Then, the control unit is called to adjust the operation behavior of the device according to the data in the memory space. For example, the sound volume can be adjusted by changing the settings of a register. Or, the control unit reads the status flags in the register, updates them to the memory space, and returns them to the software of the host system.

The software of the host system transmits the SDCA audio topology control items via the SoundWire bus to control the audio device. The SDCA audio topology control item is assigned a 26-bit hierarchical address, which is transmitted to the audio device using the paging registers of the SoundWire link bus. The data included in the SDCA audio topology control item to be written to or read from the audio device is referred to as audio control data.

If there is no processing circuit corresponding to the address of an audio control item designed in the digital interface, the address cannot be recognized to read and write the control data to the memory, and the operation behavior of the SPEC cannot be completed. Since the SDCA SPEC technology will continue to evolve, new control items and new device operation behaviors will be added according to the application. When the SDCA SPEC is revised, it is necessary to add new control items to the audio function topology or define corresponding hardware operation behaviors for the new audio topology functions, which will cause compatibility problems for the audio devices, resulting in failure to support the new version of the SDCA SPEC and reducing product competitiveness.

In addition, when the SDCA SPEC is revised, it is necessary to adjust the design of the audio device to adapt to the new specifications. Such adjustments may involve significant changes, especially when the audio device is an integrated circuit (IC). Each revision or redesign of an integrated circuit may take months, which adversely affects product launch and market competitiveness. Therefore, we have designed an expansion mechanism to dynamically allocate the control item addresses that need to be supported according to different needs and applications. Even if the SDCA SPEC is revised to add new audio topology control items, they can also be supported. Therefore, if an audio device can be expanded to support the revised item in the future SDCA SPEC and the revision or redesign of the integrated circuits can be reduced, the product compatibility and competitiveness can be ensured.

### SUMMARY

Some embodiments of the disclosure relate to an audio device including an input/output interface, a search circuit, a memory and a processor. The input/output interface is configured to receive at least one SDCA audio topology control item from an audio system host. The search circuit is coupled to the input/output interface and configured to, according to a plurality of key information of the at least one SDCA audio topology control item, search an address correspondence table for a target index corresponding to the key information, point to a target control item and a target storage address through the target index, point an audio control data to be written or read to the target storage address, and transmit an interrupt signal to the processor, corresponding to the target control item. The processor, which is coupled to both the search circuit and the memory, is configured to receive the interrupt signal transmitted by the search circuit, obtain an operation program from the memory according to the interrupt signal, and execute operations at the target storage address based on the operation program to control the audio device.

Some embodiments of the disclosure relate to a control method applied to an audio device. The control method includes the following steps: by an input/output interface, receiving at least one SDCA audio topology control item, and analyzing the SDCA audio topology control item to obtain a plurality of key information; by a search circuit, searching an address correspondence table based on multiple key information to locate a target index corresponding to them. by the search circuit, pointing to a target control item and a target storage address through the target index, pointing an audio control data to the target storage address, and transmitting an interrupt signal corresponding to the target control item to a processor; by the processor, obtaining an operation program corresponding to the interrupt signal according to the interrupt signal; and, by the processor, executing operations at the target storage address based on the operation program to control the audio device.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating an audio system according to some embodiments of the present disclosure.

FIG. 2 is a schematic diagram illustrating the audio system host according to some embodiments of the present disclosure.

FIG. 3 is a schematic diagram illustrating the audio device according to some embodiments of the present disclosure.

FIG. 4 is a flowchart illustrating a control method according to some embodiments of the present disclosure.

FIG. 5 is a flowchart illustrating one of the steps in FIG. 4 according to some embodiments of the present disclosure.

FIG. 6 is a schematic diagram illustrating one of the steps in FIG. 4 according to some embodiments of the present disclosure.

FIG. 7 is a flowchart illustrating one of the steps in FIG. 4 according to some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The term “coupling” or “connecting” used herein may refer to a direct physical or electrical contact between two or more components, or to an indirect physical or electrical contact between two or more components, or to an interoperation or action of two or more components.

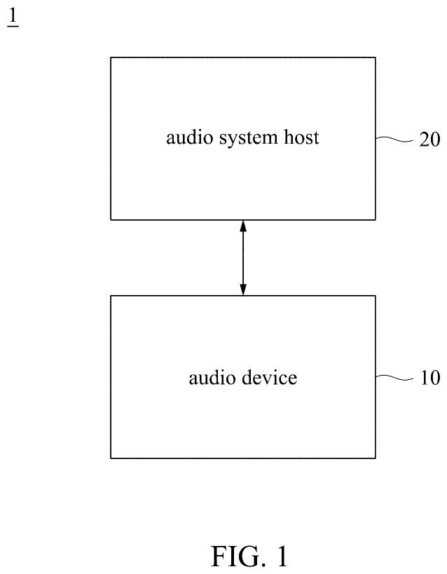

Please refer to FIG. 1. FIG. 1 is a schematic diagram illustrating an audio system 1 according to some embodiments of the present disclosure. In the embodiment of FIG. 1, the audio system 1 comprises an audio device 10 and an audio system host 20. The audio device 10 is coupled to the audio system host 20, and data/signals are transmitted between the audio device 10 and the audio system host 20 through a SoundWire link. The audio system 1 as illustrated in FIG. 1 is only for illustrative purposes, and the implementation of the present disclosure is not limited to the above.

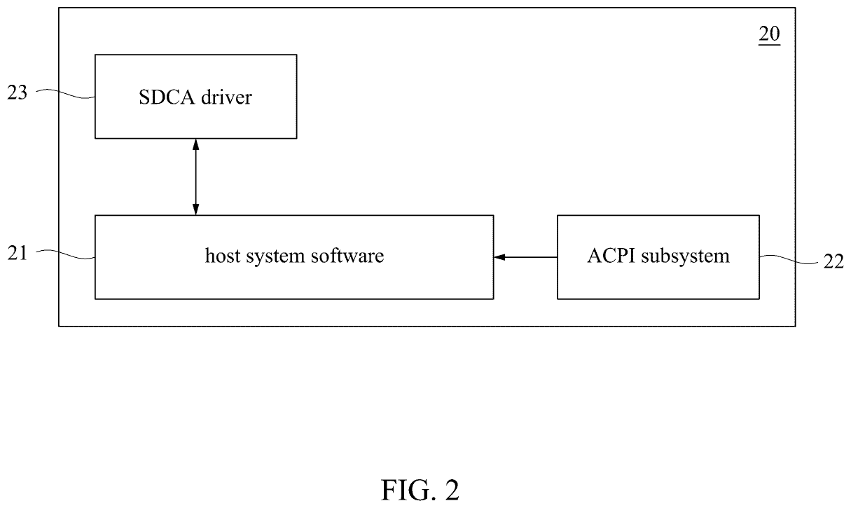

Please refer to FIG. 2. FIG. 2 is a schematic diagram illustrating the audio system host 20 according to some embodiments of the present disclosure. As shown in FIG. 2, the audio system host 20 includes a host system software 21, an advanced configuration and power interface (ACPI) subsystem 22 and a SDCA driver 23. In some embodiments, the host system software 21 is software in the audio system host 20 for executing various controls of an external device (e.g., the audio device 10 in FIG. 1).

In some embodiments, the host system software 21 utilizes the ACPI subsystem 22 to read the Discovery and Configuration (DisCo) data to obtain the information of the type of SDCA audio function topology supported by the audio device (e.g., the audio device 10 in FIG. 1), the audio function number corresponding to each SDCA audio topology control item, the entity identifier of each control, each control selector, the associated control number, and various libraries. Then, the host system software 21 selects the corresponding SDCA function driver according to the audio function topology of the audio physical device. According to the SDCA specification, the audio function number of 3 bits corresponding to each SDCA audio topology control item in the audio function topology, the entity identifier of 7 bits of each control, each control selector of 6 bits, the related control number of 6 bits, nMBQ_Atomic of 1 bit, CN_Attribute of 1 bit, and Reserved of 2 bits, are mapped to a 26-bit hierarchical address. Finally, the audio system host 20 transmits the address of the SDCA audio topology control item containing the above information to the audio device 10 as shown in FIG. 1 using the paging registers of the SoundWire link bus.

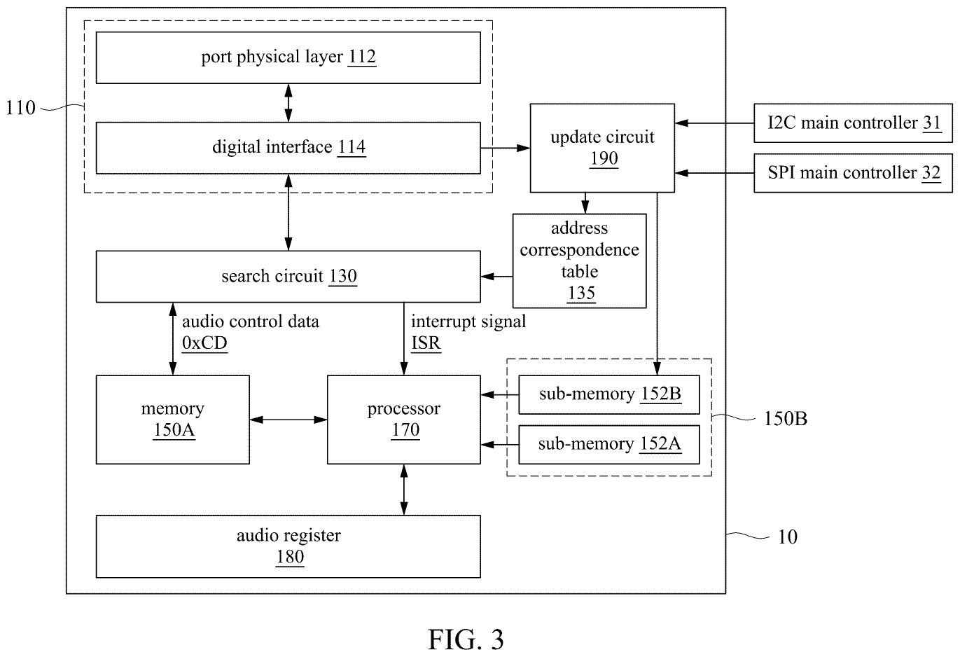

Please refer to FIG. 3. FIG. 3 is a schematic diagram illustrating the audio device 10 according to some embodiments of the present disclosure. As shown in FIG. 3, the audio device 10 comprises an input/output interface 110, a search circuit 130, an address correspondence table 135, a memory 150A, a memory 150B, a processor 170, an audio register 180 and an update circuit 190. In some embodiments, the input/output interface 110 comprises a port physical layer 112 and a digital interface 114. In some embodiments, the memory 150B comprises sub-memories 152A and 152B.

In some embodiments, the input/output interface 110 is coupled to the search circuit 130. The search circuit 130 is coupled to the memory 150A and the processor 170. The processor 170 is coupled to the memory 150B and the audio register 180. The update circuit 190 is coupled to the input/output interface 110 and the memory 150B. The update circuit 190 is coupled to an 12C main controller 31 and the SPI main controller 32 and the address correspondence table 135.

In some embodiments, the address correspondence table 135 is stored in the memory of the audio device 10. In some embodiments, the memory 150A, 150B and the memory storing the address correspondence table 135 can be the same memory or different memories.

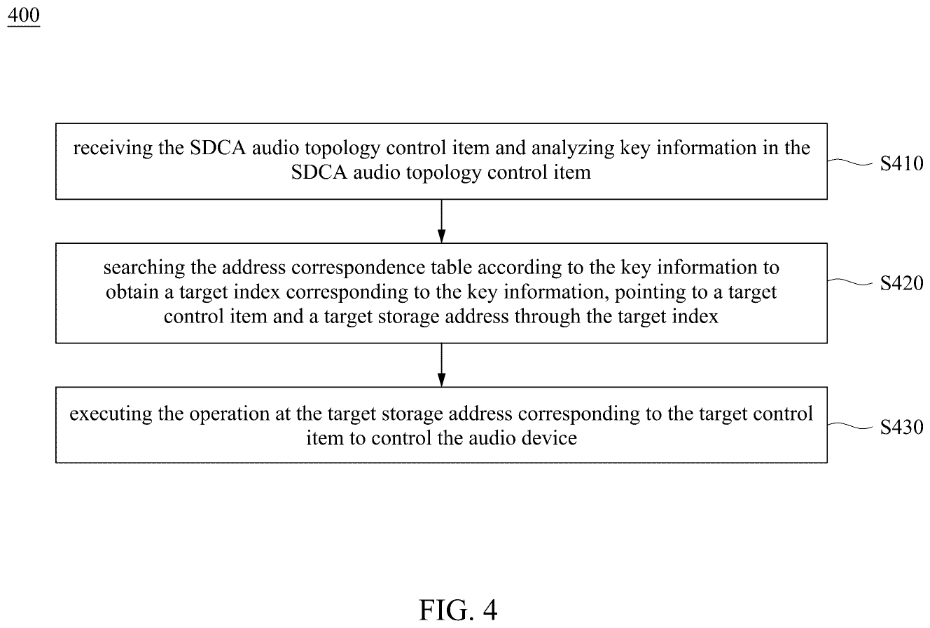

The detailed operation of the audio device 10 in FIG. 3 is described as follows with reference to FIG. 4.

Please refer to FIG. 4. FIG. 4 is a flowchart illustrating a control method 400 according to some embodiments of the present disclosure. The control method 400 can be applied to the audio device 10 as shown in FIG. 3. The control method 400 includes steps S410 to S430.

In step S410, the SDCA audio topology control item is received and key information in the SDCA audio topology control item is analyzed. In some embodiments, step S410 is executed by the input/output interface 110 of FIG. 3. In some embodiments, after the port physical layer 112 in FIG. 3 receives the audio control data from the SoundWire link bus, the port physical layer 112 decodes the audio control data and transmits the decoded audio control data to the digital interface 114. In step S410, the digital interface 114 analyzes the key information, such as the audio function number of 3 bits corresponding to the SDCA audio topology control item, the physical identifier of 7 bits, the control selector of 6 bits, and the control number of 6 bits.

In step S420, a search is executed according to the key information to address correspondence table to obtain a target index corresponding to the key information, and the target index is utilized to point to a target control item and a target storage address. In some embodiments, step S420 is executed by the search circuit 130 as shown in FIG. 3. In some embodiments, step S420 is executed by the search circuit 130 as shown in FIG. 3 via a multi-stage address matching mechanism.

In some embodiments, in step S420, the search circuit 130 is further configured to execute comparison according to the address in FIG. 3 according to the audio function number of 3 bits, the entity identifier of 7 bits, the physical identification code of 7 bits, the control selector of 6 bits, and the control number of 6 bits are sequentially compared with the address correspondence table 135 in FIG. 3.

In some embodiments, the key information further includes an omission data. In step S420, the search circuit 130 further determines whether to execute a comparison between the control number of the key information and the address correspondence table 135 in FIG. 3 according to the omission data.

The following Table 1 is one embodiment of the address correspondence table 135, but the address correspondence table 135 is not limited to the implementation in the following Table 1.

TABLE 1

| | audio | | | | | write |
|---|---|---|---|---|---|---|
| SCDA | function | entity | control | control | omission | permission |
| control | number, | identifier, | selector, | number, | data, | data, |
| index | bit [54:52] | bit [51:45] | bit [44:39] | bit [38:33] | bit [32] | bit [31:0] |
| 0 | sdca_func_sel[0] | sdca_ent[0] | sdca_csel[0] | sdca_cnum[0] | bypass_cnum[0] | sdca_rw[0] |
| 1 | sdca_func_sel[1] | sdca_ent[1] | sdca_csel[1] | sdca_cnum[1] | bypass_cnum[1] | sdca_rw[1] |
| 2 | sdca_func_sel[2] | sdca_ent[2] | sdca_csel[2] | sdca_cnum[2] | bypass_cnum[2] | sdca_rw[2] |
| . . . | . . . | . . . | . . . | . . . | . . . | . . . |
| N | sdca_func_sel[N] | sdca_ent[N] | sdca_csel[N] | sdca_cnum[N] | bypass_cnum[N] | sdca_rw[N] |

In the Table 1 above, the address correspondence table 135 has 55 bits in one row. The total number of rows in the table represents the maximum number of preset SDCA audio topology control items that can be supported, and the index is used to indicate which row of data in the address correspondence table 135.

As shown in Table 1 above, the address correspondence table 135 includes a plurality of rows 0 to N. Each row corresponds to a different preset SDCA audio topology control item, which is configured to control or adjust (e.g., changing the volume, adjusting the audio sampling rate, or controlling the power switch) an external device (e.g., audio device 10 in FIG. 1). Each control item in the address correspondence table 135 includes its own audio function number, entity identifier, control selector, control number, omission data and write permission data.

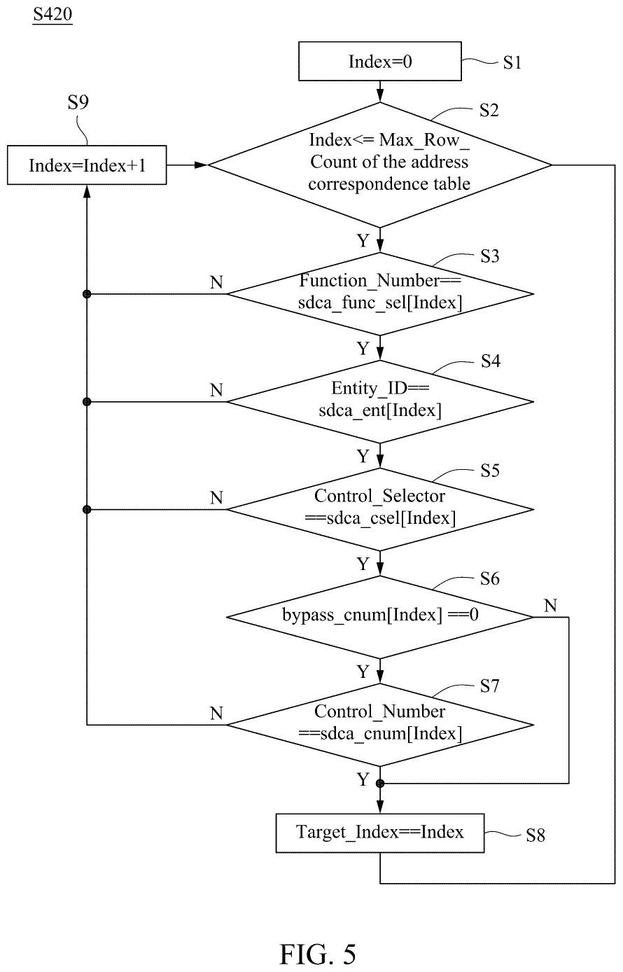

Please refer also to FIG. 5. FIG. 5 is a flowchart illustrating the process of obtaining the target control item according to the key information in step S420 of FIG. 4 according to some embodiments of the present disclosure. As shown in FIG. 5, step S420 includes steps S1 to S9.

In step S1, the index is initially set to 0.

In step S2, it is determined whether the index does not exceed the maximum number of the rows in the address correspondence table 135. If not exceeding, step S3 is executed; if exceeding, it means that all the rows in the address correspondence table 135 have been compared, and the corresponding information for the preset SDCA audio topology control item corresponding to the key information cannot be found.

In step S3, it is compared whether the audio function number of the key information is equal to sdca_func_sel[Index]. If so, step S4 is executed; otherwise, the value of the index is increased by 1 and the process is back to step S2.

In step S4, it is compared whether the entity identifier is equal to sdca_ent[Index]. If so, step S5 is executed; otherwise, the value of the index is increased by 1 and the process is back to step S2.

In step S5, it is compared whether the control selector is equal to sdca_csel[Index]. If so, step S6 is executed; otherwise, the value of the index is increased by 1 and the process is back to step S2.

In step S6, it is determined whether bypass_cnum[Index] is equal to 0. If so, step S7 is executed; otherwise, there is no need to compare the control number, and step S8 is directly executed.

In step S7, it is compared whether the control number is equal to sdca_cnum[Index]. If so, step 8 is executed; otherwise, the value of the index is increased by 1 and the process is back to step S2.

In step S8, the target index for identifying the SDCA audio topology control item corresponding to the key information is successfully found (i.e., the value of the index when the matching is successful), and the corresponding target control item and target storage address are pointed to through the target index.

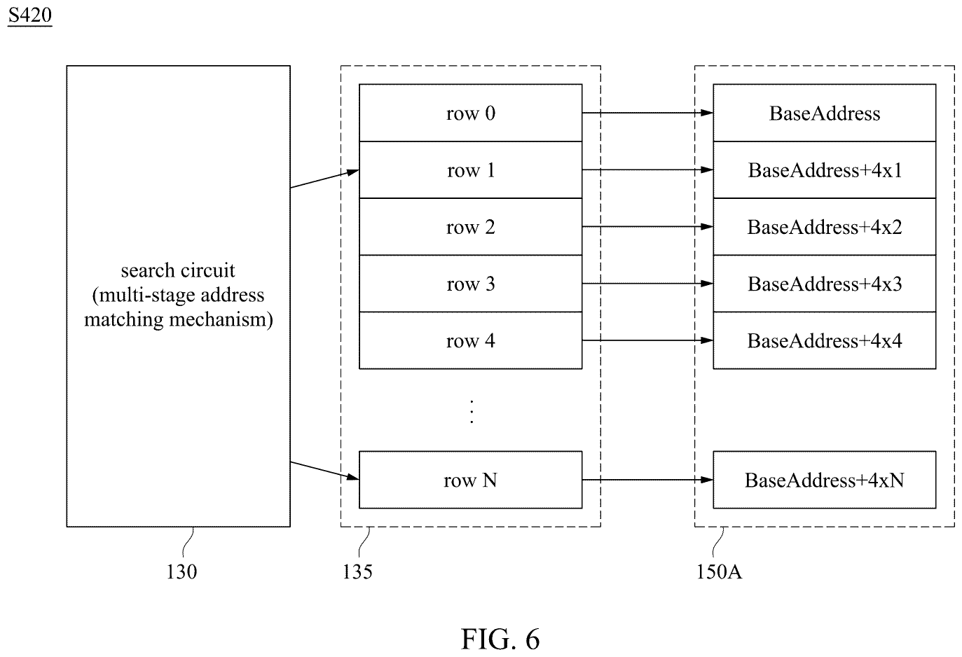

Please refer also to FIG. 6. FIG. 6 is a schematic diagram illustrating the process of obtaining the target storage address corresponding to the key information in step S420 of FIG. 4 according to some embodiments of the present disclosure. In some embodiments, the target storage address is located in the memory 150A of FIG. 3. In some embodiments, the search circuit 130 points each preset SDCA audio topology control item corresponding to each row of the address correspondence table 135 to a corresponding 4-byte physical memory storage space in memory 150A. The aforementioned corresponding 4-byte physical memory storage space is the target storage address.

In some embodiments, the search circuit 130 in FIG. 3 calculates the target storage address according to the target index. In some embodiments, the search circuit 130 calculates the target storage address according to the following equation (1):

$$TargetAddress = BaseAddress + 4 \times N . \qquad equation ( 1 )$$

TargetAddress in the above equation (1) is the target storage address corresponding to the target index. BaseAddress is the target storage address pointed to by the first row of the address correspondence table 135. N is the target index. The above BaseAddress is determined according to the physical memory address in the memory 150A of the audio device 10.

In some embodiments, after obtaining the target storage address, the search circuit 130 stores or reads the audio control data (e.g., the audio control data 0xCD in FIG. 3) of the SDCA audio topology control item corresponding to the target control item at the pointed target storage address.

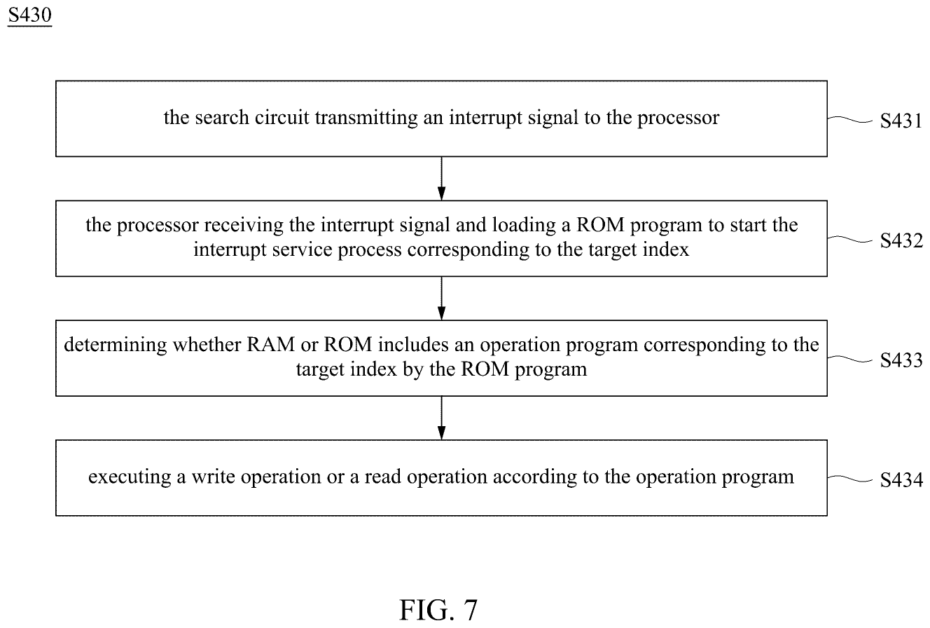

In step S430, the operation is executed at the target storage address corresponding to the target control item to control the audio device. Please refer also to FIG. 7. FIG. 7 is a flowchart illustrating step S430 in FIG. 4 according to some embodiments of the present disclosure. As shown in FIG. 7, step S430 includes steps S431 to S434.

In step S431, the search circuit transmits an interrupt signal to the processor. In some embodiments, after the search circuit 130 as shown in FIG. 3 obtains the target index corresponding to the preset SDCA audio topology control item of the key information, the search circuit 130 generates an interrupt signal ISR mapped to the target index, and transmits the interrupt signal ISR to the processor 170.

In step S432, the processor receives the interrupt signal and loads a ROM program to start the interrupt service process corresponding to the target index (e.g., a process of interrupt service routine).

Please refer also to FIG. 3. In some embodiments, the sub-memory 152A in FIG. 3 is a read-only memory (ROM), and the sub-memory 152B is a random access memory (RAM). In some embodiments, after receiving the interrupt signal ISR, the processor 170 in FIG. 3 reads the firmware program code stored in ROM to start the interrupt service process corresponding to the target index and the interrupt signal ISR.

In step S433, it is determined whether the RAM or ROM includes an operation program corresponding to the target index by the ROM program. In some embodiments, the firmware program stored in the ROM (e.g., the sub-memory 152A in FIG. 3) is a fixed operation behavior designed during the development of the audio device 10 according to the then-current SPEC version of the SDCA. The firmware program stored in RAM (e.g., the sub-memory 152B in FIG. 3) is designed to implement new device operation behaviors added to the latest version of the SDCA SPEC, or to correct the existing incorrect operation behaviors.

In some embodiments, in step S433, the processor 170 first searches the RAM (e.g., the sub-memory 152B in FIG. 3) according to the interrupt signal ISR to see if there is an operation program corresponding to the interrupt signal ISR (e.g., an operation program of interrupt service routine). If the RAM does not include the operation program corresponding to the interrupt signal ISR, the processor 170 further searches the ROM (e.g., the sub-memory 152A in FIG. 3) for the operation program corresponding to the interrupt signal ISR.

In step S434, a write operation or a read operation is executed according to the operation program. In some embodiments, step S434 is executed by the processor 170 in FIG. 3.

The target storage address has an unrestricted read permission but a restricted write permission. Please refer also to Table 1 above. In some embodiments, the address correspondence table 135 includes a write permission data. When the write permission data includes the write permission, the audio system host 20 in FIG. 1 transmits the SDCA audio topology control item to the target storage address, and the write operation is allowed. When the write permission data in the address correspondence table 135 does not include the write permission, the audio system host 20 transmits the audio control data to the target storage address for execution, and only the read operation is allowed.

In some embodiments, when the value in the write permission data is 1 in the address correspondence table 135, it indicates that the writing is allowed, and when the value in the write permission data is 0, it indicates that the writing is not allowed.

In some embodiments, there are many types of interrupt signals. The search circuit 130 determines whether the SDCA audio control function item in the current bus belongs to a write or read operation according to the input/output interface 110's analysis result, and send a write-type interrupt signal or a read-type interrupt signal to the processor 170.

In some embodiments, when the audio system host 20 transmits the SDCA audio topology control item to the target storage address to execute the audio control data 0xCD write operation, the search circuit 130 transmits the write-type interrupt signal ISR to the processor 170. The processor 170 reads the audio control data 0xCD corresponding to the SDCA audio control item from the target storage address according to the write-type interrupt signal ISR, and starts the interrupt service process to adjust the value of the audio register 180 (or the current state of the audio register 180) according to audio control data 0xCD.

When executing the read operation and after pointing the SDCA audio topology control item to the target storage address, the search circuit 130 transmits a read-type interrupt signal ISR to the processor 170. The processor 170 retrieves the value (or current state) of the audio register 180 according to the read-type interrupt signal ISR and the corresponding operation program (or the interrupt service process) for the read operation of the bus, and writes the value of the audio register 180 to the target storage address to update the audio control data 0xCD. After the audio control data 0xCD stored at the target storage address is updated, the audio control data 0xCD is returned from the target storage address to the audio system host 20 in FIG. 1 via the input/output interface 110.

Please refer back to FIG. 3. In some embodiments, the update circuit 190 in the audio device 10 is configured to update the address correspondence table 135 and the programs stored in the RAM (e.g., the sub-memory 152B). In some embodiments, when adjusting the control items of the SDCA audio function topology supported by the audio system 1, via the SoundWire link bus between the audio device 10 and the audio system host 20 as shown in FIG. 1, an external serial communication bus (12C) main controller 31 or an external serial peripheral interface (SPI) main controller 32, the updating circuit 190 modifies the address correspondence table 135. In some embodiments, when augmenting the operation behavior of the control audio device 10, via the SoundWire link bus between the audio device 10 and the audio system host 20 as shown in FIG. 1, an external serial communication bus (12C) main controller 31 or an external serial peripheral interface (SPI) main controller 32, the update circuit 190 adds new firmware programs to the memory space in RAM (e.g., the sub-memory 152B) to update the programs stored in RAM.

In summary, the present disclosure provides an audio device and a control method. In the embodiments of the present disclosure, the address correspondence table can be set to an initial value so that the audio device can support the latest version of the SDCA SPEC at the time of shipment. If the SDCA SPEC is subsequently revised, the internal data of the address correspondence table is updated by the update circuit to support the identification of the information in the new control items of the SDCA audio function topology, and provide the corresponding memory space at the same time for the host system software to execute read and write operations, and send the associated interrupt signals to notify the processor to adjust or read the audio register according to the operation behaviors defined in the SDCA SPEC.

In addition, the patch firmware program is written to the RAM memory space by the update circuit. After the processor receives the interrupt signal sent by the multi-stage address matching mechanism, the processor can read the newly added patch firmware program in the RAM to support the new operation behaviors added after the revision of the SDCA SPEC, such as adjusting the audio register to change the sound volume, reading the status flag of the audio register, etc. In addition to adding new operations, the patch firmware code can also be configured to correct the existing incorrect operation behaviors.

Furthermore, in the embodiments of the present disclosure, based on the multi-stage address matching mechanism, a row of data in the address correspondence table can be found for identifying the address of the audio topology control item and points the data of the control item to a specific memory space. The SDCA audio topology control item address is a 26-bit hierarchical address, and the memory range corresponding to the 26 bits is 64 megabytes (MBytes). Assuming that the audio device is expected to support a maximum of N audio topology control items, only N×4 memory space is required. This design approach effectively saves the memory space and does not require the design of the memory with the complete 64 megabytes (Mbytes) of in the product.

In some embodiments, the processor 170 shown in FIG. 3 can be, but is not limited to, a single processor or a combination of multiple microprocessors (e.g., CPUs or GPUs).

In some embodiments, the memory can be a non-transitory computer-readable recording medium storing at least one instruction associated with the control method 400. The at least one instruction can be accessed and executed by the processor 170.

The various functional elements are disclosed herein. To one of ordinary skill in the art, the functional elements can be implemented by electrical circuits (regardless of the application-specific circuits or the general-purpose circuits operating under the control of one or more processors and programmed instructions).

Although the present invention has been described in considerable detail with reference to certain embodiments thereof, other embodiments are possible. Therefore, the spirit and scope of the appended claims should not be limited to the description of the embodiments contained herein.

What is claimed is:

1. An audio device, comprising:
an input/output interface, configured to receive at least one SDCA audio topology control item from an audio system host;
a search circuit coupled to the input/output interface, the search circuit being configured to, according to a plurality of key information of the at least one SDCA audio topology control item, search an address correspondence table for a target index corresponding to the key information, point to a target control item and a target storage address through the target index, point an audio control data to the target storage address, and transmit an interrupt signal corresponding to the target control item;
a memory; and
a processor coupled to the search circuit and the memory, the processor being configured to receive the interrupt signal transmitted by the search circuit, obtain an operation program corresponding to the interrupt signal from the memory according to the interrupt signal, and execute operations at the target storage address based on the operation program to control the audio device.

2. The audio device according to claim 1, wherein the memory comprises:
a first sub-memory, configured to store a plurality of first programs; and
a second sub-memory, configured to store a plurality of second programs, wherein the second programs are updated by an update circuit.

3. The audio device according to claim 2, wherein the processor is further configured to, according to the interrupt signal, first search the second sub-memory for the operation program corresponding to the interrupt signal, and then search the first sub-memory for the operation program corresponding to the interrupt signal if the second sub-memory does not comprise the operation program corresponding to the interrupt signal.

4. The audio device according to claim 1, wherein the key information comprises an audio function number, an entity identifier, a control selector and a control number corresponding to the at least one SDCA audio topology control item, wherein the search circuit is further configured to serially execute comparisons of the audio function number, the entity identifier, the control selector and the control number corresponding to the at least one SDCA audio topology control item with the address correspondence table.

5. The audio device according to claim 4, wherein the key information further comprises an omission data, and the search circuit is further configured to determine whether executing the comparisons based on the control number according to the omission data.

6. The audio device according to claim 1, wherein the address correspondence table comprises a write permission data, wherein when the write permission data comprises a write permission, the processor is further configured to execute a write operation at the target storage address, when the write permission data does not comprise the write permission, the processor is further configured to execute a read operation at the target storage address.

7. The audio device according to claim 6, wherein the processor is further configured to write a value of an audio register corresponding to the interrupt signal at the target storage address when executing the read operation, the processor is further configured to adjust the value of the audio register according to the audio control data at the target storage address when executing the write operation.

8. The audio device according to claim 1, wherein the address correspondence table comprises a plurality of rows, each of the rows is corresponding to a preset SDCA audio topology control item, wherein the search circuit is further configured to determine that the at least one SDCA audio topology control item is corresponding to one of the rows according to the key information, and obtain the target index of the one of the rows.

9. The audio device according to claim 8, wherein the search circuit is further configured to calculate the target storage address according to the target index.

10. The audio device according to claim 1, further comprising:
an update circuit, configured for updating the address correspondence table.

11. A control method, applied to an audio device, wherein the control method comprises:
by an input/output interface, receiving at least one SDCA audio topology control item, and analyzing the SDCA audio topology control item to obtain a plurality of key information;
by a search circuit, searching an address correspondence table based on the key information to locate a target index corresponding to the key information;
by the search circuit, pointing to a target control item and a target storage address through the target index, pointing an audio control data to the target storage address, and transmitting an interrupt signal corresponding to the target control item to a processor;
by the processor, obtaining an operation program corresponding to the interrupt signal according to the interrupt signal; and
by the processor, executing operations at the target storage address based on the operation program to control the audio device.

12. The control method according to claim 11, wherein the audio device comprises a memory, and the memory comprises a first sub-memory and a second sub-memory, wherein the control method further comprises:
by the first sub-memory, storing a plurality of first programs; and
by the second sub-memory, storing a plurality of second programs, wherein the second programs are updated by an update circuit.

13. The control method according to claim 12, wherein the step of obtaining the operation program corresponding to the interrupt signal according to the interrupt signal comprises:
first searching the second sub-memory for the operation program corresponding to the interrupt signal according to the interrupt signal; and
searching the first sub-memory for the operation program corresponding to the interrupt signal if the second sub-memory does not comprise the operation program corresponding to the interrupt signal.

14. The control method according to claim 11, wherein the key information comprises an audio function number, an entity identifier, a control selector and a control number corresponding to the at least one SDCA audio topology control item, wherein the step of searching the address correspondence table based on the key information comprises:
serially executing comparisons of the audio function number, the entity identifier, the control selector and the control number with the address correspondence table.

15. The control method according to claim 14, wherein the key information further comprises an omission data, wherein the step of searching the address correspondence table based on the key information further comprises:
determining whether executing the comparisons based on the control number according to the omission data.

16. The control method according to claim 11, wherein the address correspondence table comprises a write permission data, wherein the step of executing the operations at the target storage address based on the operation program further comprises:
when the write permission data comprises a write permission, executing a write operation at the target storage address; and
when the write permission data does not comprise the write permission, executing a read operation at the target storage address.

17. The control method according to claim 16, further comprising:
when executing the read operation, writing a value of an audio register corresponding to the interrupt signal at the target storage address; and
when executing the write operation, adjusting the value of the audio register according to the audio control data at the target storage address.

18. The control method according to claim 11, wherein the address correspondence table comprises a plurality of rows, each of the rows is corresponding to a preset SDCA audio topology control item, wherein the step of searching the address correspondence table based on the key information comprises:
determining that the at least one SDCA audio topology control item is corresponding to one of the rows according to the key information, and obtaining the target index of the one of the rows.

19. The control method according to claim 18, further comprising:
calculating the target storage address according to the target index.

20. The control method according to claim 11, further comprising:
by an update circuit, updating the address correspondence table.
